(19) United States
(12) Patent Application Publication
(10) Pub. No.: US 2016/0349963 A1
(43) Pub. Date: Dec. 1, 2016

(54) METHOD AND APPARATUS FOR MANAGING TERMINAL APPLICATION

(71) Applicant: Xiaomi Inc., Beijing (CN)

(72) Inventors: Fei XIANGLI, Beijing (CN); Zhuang QIAN, Beijing (CN); Shengbo CHENG, Beijing (CN)

(21) Appl. No.: 15/156,432

(22) Filed: May 17, 2016

(30) Foreign Application Priority Data
May 29, 2015 (CN) 201510291090.9

(51) Int. Cl. G06F 3/0481; G06F 3/0484

(52) U.S. Cl. CPC G06F 3/04817; G06F 3/04842

(57) ABSTRACT

The present disclosure refers to a method and an apparatus for managing an application in a terminal. The method includes: displaying at least one target folder in a visible area of a current desktop, when monitoring that there is a between-folder moving trigger event of an application icon, the target folder being different a first folder where the application icon is located; and, when monitoring that there is a between-folder moving end event of the application icon, determining a selected target folder from the at least one target folder, deleting the application icon from the first folder, and adding the application icon into the selected target folder. The present may simplify a manual operation of a user for moving an application icon.

### CROSS-REFERENCE TO RELATED APPLICATIONS

This application is based upon and claims priority to Chinese Patent Application Serial No. 201510291090.9, filed on May 29, 2015, the entire contents of which are incorporated herein by reference.

### TECHNICAL FIELD

The present disclosure relates to the field of electronic terminals and, more particularly, to a method and an apparatus for managing a terminal application.

### BACKGROUND

Many smart phone users tend to organize and store applications in folders. With an increase of daily applications, the application folders on the desktop have played a more and more important role.

In most current operating systems of mobile terminals, a general operation process for moving an application from one folder to another folder includes the following steps:

1. opening the folder where the application is located;

2. pressing and holding down the application in the folder;

3. dragging the application to leave the folder interface (system screen is switched);

4. dragging the application on the desktop to find a target folder;

5. dragging the application and suspend the application above the target folder until the target folder opens automatically (system screen is switched); and

6. releasing the holding of the application, after selecting the position for placing the application in the target folder.

### SUMMARY

In order to overcome the problems existing in the related art, embodiments of the present disclosure provide a method and an apparatus for managing a terminal application, which can simplify a user's operation while managing a terminal application.

According to a first aspect of embodiments of the present disclosure, there is provided a method for managing a terminal application, including: displaying at least one target folder in a visible area of a current desktop, when monitoring that there is a between-folder moving trigger event of an application icon, the target folder being different from a first folder where the application icon is located; and determining a selected target folder from the at least one target folder, deleting the application icon from the first folder and adding the application icon into the selected target folder, when monitoring that there is a between-folder moving end event of the application icon.

According to a second aspect of embodiments of the present disclosure, there is provided an apparatus for managing a terminal application, including: a processor; and a memory for storing instructions executable by the processor. The processor is configured to: display at least one target folder in a visible area of a current desktop, when monitoring that there is a between-folder moving trigger event of an application icon, the target folder being different from a first folder where the application icon is located; and determine a selected target folder from the at least one target folder, delete the application icon from the first folder, and add the application icon into the selected target folder, when monitoring that there is a between-folder moving end event of the application icon.

According to a third aspect of embodiments of the present disclosure, there is provided non-transitory storage medium having stored therein instructions that, when executed by one or more processors of a terminal for managing a terminal application, cause the terminal to perform: displaying at least one target folder in a visible area of a current desktop, when monitoring that there is a between-folder moving trigger event of an application icon, the target folder being different from a first folder where the application icon is located; and determining a selected target folder from the at least one target folder, deleting the application icon from the first folder, and adding the application icon into the selected target folder, when monitoring that there is a between-folder moving end event of the application icon.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for managing a terminal application according to an exemplary embodiment.

FIG. 2 is a flow chart showing a method for managing a terminal application according to an exemplary embodiment.

FIG. 3 is a flow chart showing a method for managing a terminal application according to an exemplary embodiment.

FIG. 4A is a schematic diagram showing a desktop displaying effect of a terminal before operation, according to an exemplary embodiment.

FIG. 4B is a schematic diagram showing a desktop displaying effect of a terminal when an application icon is removed from a first folder, according to an exemplary embodiment.

FIG. 4C is a schematic diagram showing a displaying effect when the application icon in the first folder is pressed, according to an exemplary embodiment.

FIG. 4D is a schematic diagram showing a displaying effect when the application icon in the first folder is removed and a current active interface of the desktop is still an interface showing the first folder, according to an exemplary embodiment.

FIG. 5 is a block diagram of an apparatus for managing a terminal application according to an exemplary embodiment.

FIG. 6 is a block diagram of an apparatus for managing a terminal application according to an exemplary embodiment.

FIG. 7 is a block diagram of a target folder displaying module according to an exemplary embodiment.

FIG. 8 is a block diagram of a between-folder moving module according to an exemplary embodiment.

FIG. 9 is a block diagram of a monitoring module according to an exemplary embodiment.

FIG. 10 is a block diagram of an apparatus for managing a terminal application according to an exemplary embodiment.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of apparatuses and methods consistent with aspects related to the invention as recited in the appended claims.

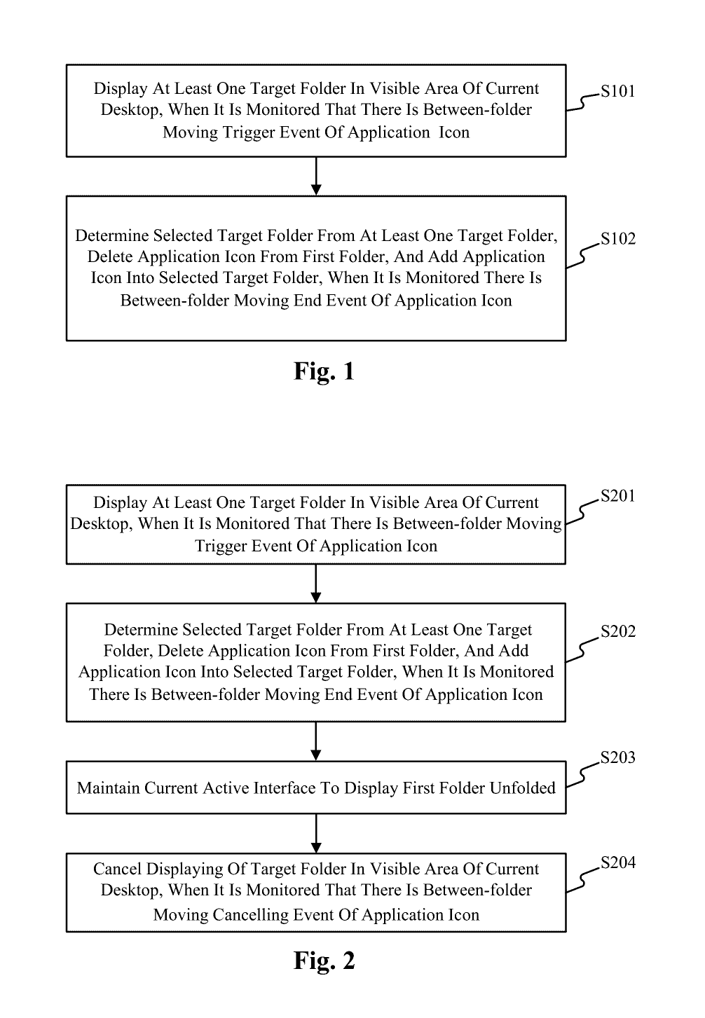

FIG. 1 is a flow chart showing a method for managing a terminal application according to an exemplary embodiment. As shown in FIG. 1, the method for managing a terminal application is used in managing and organizing applications in a terminal apparatus, such as a mobile phone, a camera, and a panel computer, and includes the following steps.

In step 101, at least one target folder is displayed in a visible area of a current desktop, when it is monitored that there is a between-folder moving trigger event of an application icon. The target folder is different from a first folder where the application icon is located.

In step 102, when it is monitored there is a between-folder moving end event of the application icon, a selected target folder is determined from the at least one target folder. The application icon is deleted from the first folder and is added into the selected target folder.

In the solution above, when it is monitored that there is the between-folder moving trigger event of the application icon, at least one target folder is displayed in the visible area of the current desktop; and when it is monitored that there is the between-folder moving end event of the application icon, a selected target folder is determined from the at least one target folder, the application icon is deleted from the first folder, and the application icon is added into the selected target folder. During the whole process for moving the application icon, it does not need too much manual operation of the user, thus simplifying an operation process.

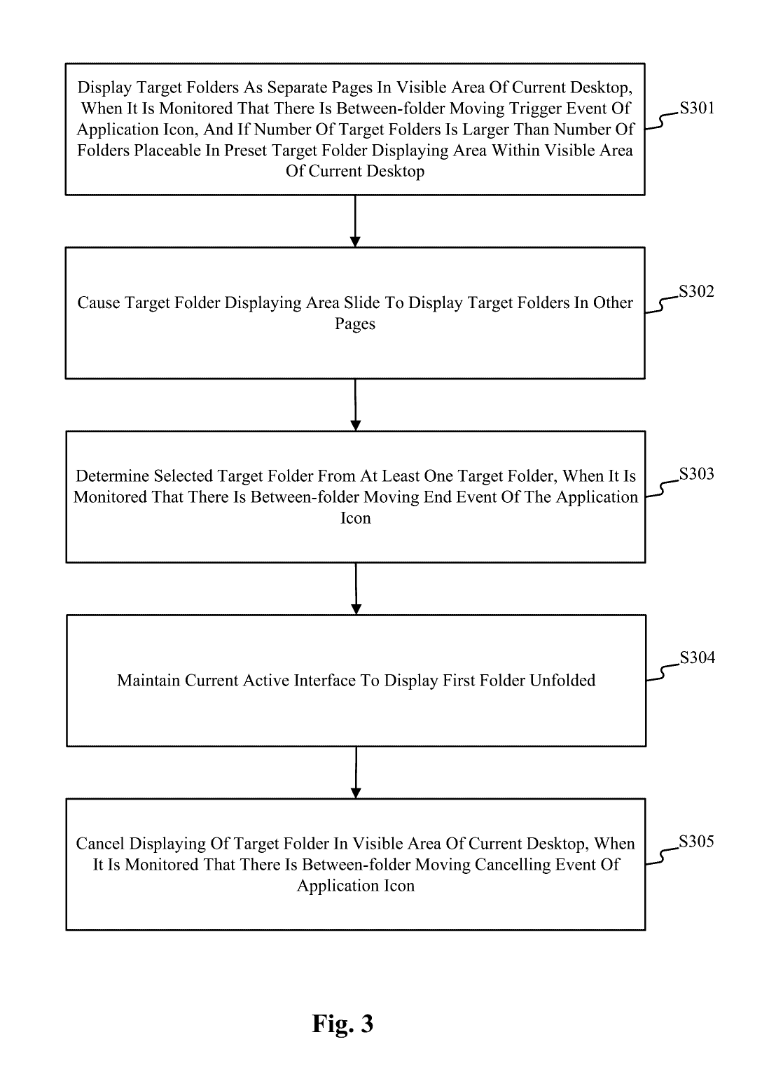

FIG. 2 is a flow chart showing a method for managing a terminal application according to an exemplary embodiment. As shown in FIG. 2, the method for managing a terminal application is used in managing and organizing applications in a terminal apparatus, such as a mobile phone, a camera, and a panel computer, and includes the following steps.

In step 201, at least one target folder is displayed in a visible area of a current desktop, when it is monitored that there is a between-folder moving trigger event of an application icon. The target folder is different from a first folder where the application icon is located.

For example, the application icon is a shortcut icon of an application.

In one exemplary embodiment, monitoring that there is a between-folder moving trigger event of an application icon includes: monitoring that there is a predetermined action performed on the application icon to be moved in the first folder which is unfolded. The predetermined action may be that a shortcut icon of the application to be moved is in a pressed state for a preset period, or may be a circling action on the shortcut icon of the application to be moved.

In one exemplary embodiment, displaying at least one target folder in the visible area of the current desktop includes: displaying folders other than the first folder of the current desktop in the visible area of the current desktop.

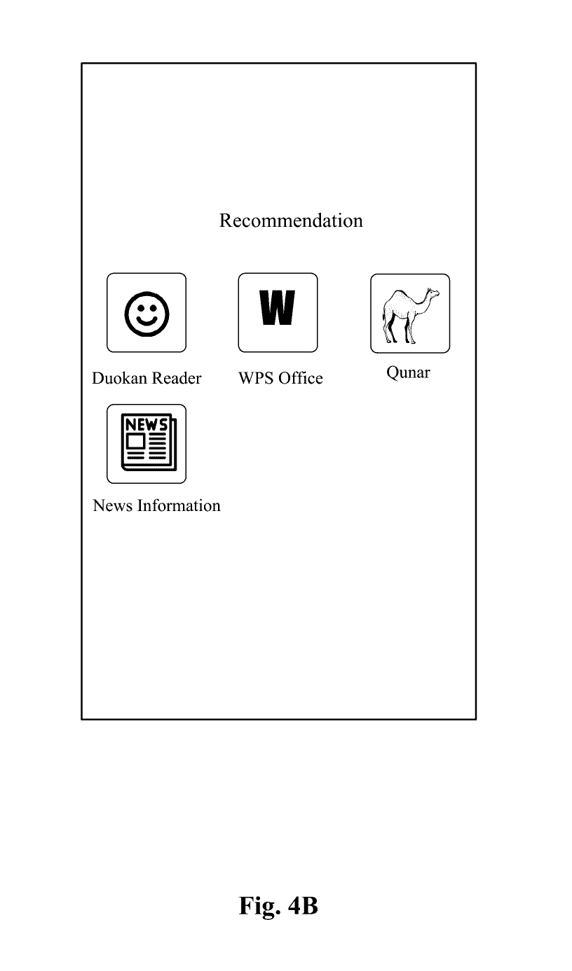

In one exemplary embodiment, displaying at least one target folder in a visible area of a current desktop includes: displaying folders of all desktops other than the first folder in the visible area of the current desktop. This step is applicable for a scene in which the terminal has a plurality of operation interfaces, that is, a scene in which the terminal has a plurality of desktops. As shown in FIG. 4A, which is a diagram showing a desktop displaying effect of a terminal before operation, the first folder (i.e., the folder where the application to be moved is located) includes a WPS Office application icon, a Duokan Reader application icon, etc. As shown in FIG. 4C, which is a schematic diagram showing a desktop of a terminal when the between-folder moving trigger event of the application icon is monitored, a plurality of target folders are displayed in the visible area of the current desktop, e.g., at a bottom of a display screen.

In one exemplary embodiment, displaying at least one target folder in the visible area of the current desktop may be displaying only target folders, rather than displaying application icons contained in each target folder. In one exemplary embodiment, displaying at least one target folder in the visible area of the current desktop may be not only displaying the target folders, but also displaying the application icons contained in each target folder, as shown in FIG. 4C.

In step 202, when it is monitored there is a between-folder moving end event of the application icon, a selected target folder is determined from the at least one target folder, and the application icon is deleted from the first folder and is added into the selected target folder.

In one exemplary embodiment, monitoring that there is a between-folder moving end event of the application icon includes: monitoring that the application icon is switched from a pressed state to a released state. FIG. 4C is a schematic diagram showing a displaying effect when an application icon in the first folder is pressed.

In one exemplary embodiment, monitoring that there is a between-folder moving end event of the application icon includes: monitoring that there is a selecting operation on the target folder. The selecting operation may be predetermined.

In one exemplary embodiment, deleting the application icon from the first folder and adding the application icon into the selected target folder includes: deleting the application icon from the first folder, arranging application icons other than the application icon in the first folder according to a preset rule, and displaying the arranged application icons in the first folder; and adding the application icon into a preset location in the selected target folder. The preset rule may be predetermined, e.g., arranging application icons according to a size, a name, or a modification time of each application icon. FIG. 4D is a schematic diagram showing a displaying effect when the application icon that is pressed in FIG. 4C is removed from the first folder and is moving to a selected target folder.

It may be seen that, in above embodiments, during the whole process for moving the application icon, the user does not need too much manual operation, thus simplifying an operation process.

In one exemplary embodiment, the method may further include step 203.

In step 203, a current active interface is maintained to display the first folder unfolded. For example, FIG. 4D is a schematic diagram showing displaying effect when the application icon that is pressed in FIG. 4C is removed from the first folder and the first folder unfolded is still displayed as the current active interface.

In the above embodiments, during the process for moving the application icon from the first folder, there is no switching in system pages, and a current page is maintained as the first folder where the application icon moved is located before being moved, and thus it is convenient for the user to continue performing moving operations on other application icons in the first folder.

In one exemplary embodiment, the method may further include step 204.

In step 204, displaying of the target folder is cancelled in the visible area of the current desktop, when it is monitored that there is a between-folder moving cancelling event of the application icon.

In one exemplary embodiment, monitoring that there is a between-folder moving cancelling event of the application icon includes: monitoring that a preset cancellation action is performed on the current desktop, the preset cancellation action being corresponding to a between-folder moving cancelling operation of the application icon. The preset cancellation action may be predetermined, and the correspondence between the preset cancellation action and between-folder moving cancelling operation of the application icon may also be predetermined.

In one exemplary embodiment, monitoring that there is a between-folder moving cancelling event of the application icon includes: monitoring that there is a preset cancelling operation on a preset key of the terminal, the preset cancelling operation on the preset key being corresponding to a between-folder moving cancelling operation of the application icon. The preset cancelling operation may be predetermined. The correspondence between the preset cancelling operation on the preset key and the between-folder moving cancelling operation of the application icon may also be predetermined.

In the above embodiments, the user may conveniently terminate the operation of moving the application via operations.

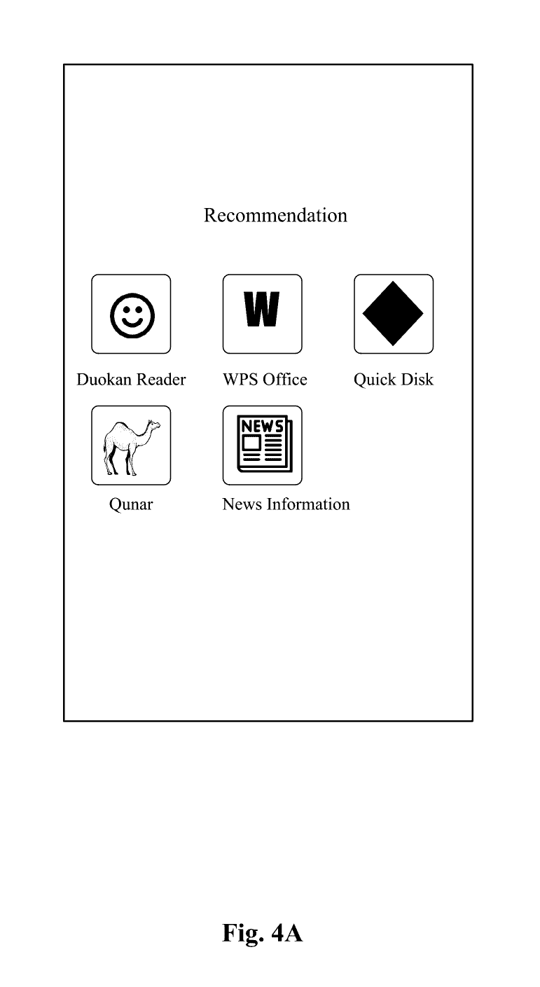

FIG. 3 is a flow chart showing a method for managing a terminal application according to an example embodiment. As shown in FIG. 3, the method for managing a terminal application is used in a terminal apparatus, such as a mobile phone, a camera and a panel computer, and includes the following steps.

In step 301, when it is monitored that there is a between-folder moving trigger event of an application icon, and if a number of target folders is larger than a number of folders placeable in a preset target folder displaying area within the visible area of the current desktop, the target folders are displayed in separate pages in the visible area of the current desktop. The target folder is different from a first folder where the application icon is located. The application icon herein is a shortcut icon of an application.

In one exemplary embodiment, monitoring that there is a between-folder moving trigger event of an application icon includes: monitoring that there is a predetermined action performed on the application icon to be moved in the first folder unfolded, for instance, monitoring that a shortcut icon of the application to be moved is in a pressed state for a preset period, or monitoring that there is a circling action on the shortcut icon of the application to be moved.

In one exemplary embodiment, displaying at least one target folder in the visible area of the current desktop includes: displaying folders other than the first folder of the current desktop in the visible area of the current desktop. In one exemplary embodiment, displaying at least one target folder in a visible area of a current desktop includes: displaying folders other than the first folder of all desktops in the visible area of the current desktop. This step is applicable for a scene in which a terminal has a plurality of operation interfaces, that is, a scene in which the terminal has a plurality of desktops. As shown in FIG. 4A, which is a schematic diagram showing a desktop displaying effect of a terminal before operation, the first folder (i.e., the folder where the application to be moved is located) includes a WPS Office application icon, a Duokan Reader application icon, etc. As shown in FIG. 4B, which is a schematic diagram showing a desktop displaying effect of a terminal when the between-folder moving trigger event of the application icon is monitored, e.g., when an application icon in the first folder is pressed, a plurality of target folders are displayed in the visible area of the current desktop, e.g., at a bottom of a display screen.

In step 302, the target folder displaying area is caused to slide to display target folders in other pages. For example, a user can slide the target folder displaying area, such that the target folder display area can display target folders in other pages.

In step 303, when it is monitored that there is a between-folder moving end event of the application icon, a selected target folder is determined from the at least one target folder, and the application icon is deleted from the first folder and is added into the selected target folder.

In one exemplary embodiment, monitoring that there is a between-folder moving end event of the application icon includes: monitoring that the application icon is switched from a pressed state to a released state. FIG. 4C is a diagram showing a displaying effect when an application icon in the first folder is pressed. In one exemplary embodiment, monitoring that there is a between-folder moving end event of the application icon includes: monitoring that there is a selecting operation on the target folder. The selecting operation may be determined according to actual demands. The selecting operation may be predetermined.

In one exemplary embodiment, deleting the application icon from the first folder and adding the application icon into the selected target folder includes: deleting the application icon from the first folder, arranging application icons other than the application icon in the first folder according to a preset rule, and displaying the arranged application icons in the first folder; and adding the application icon into a preset location in the selected target folder. The preset rule may be predetermined, e.g., arranging application icons according to a size, a name, or a modification time of each application icon.

It may be seen that, in above embodiments, during the whole process for moving the application icon, the user does not need too much manual operation, thus simplifying an operation process.

In one exemplary embodiment, the method may further include step 304.

In step 304, a current active interface is maintained to display the first folder which is unfolded. For example, FIG. 4D is a diagram showing displaying effect when the application icon that is pressed in FIG. 4C is removed from the first folder and the first folder unfolded is still displayed as the current active interface.

In the above embodiments, during the process for moving the application icon from the first folder, there is no switching in system pages, and a current page is maintained as the first folder where the application icon moved is located before being moved, and thus it is convenient for the user to continue performing moving operations on other application icons in the first folder.

In one exemplary embodiment, the method may further include step 305.

In step 305, displaying of the target folder is cancelled in the visible area of the current desktop, when it is monitored that there is a between-folder moving cancelling event of the application icon.

In one exemplary embodiment, monitoring that there is a between-folder moving cancelling event of the application icon includes: monitoring that a preset cancellation action is performed on the current desktop, the preset cancellation action being corresponding to a between-folder moving cancelling operation of the application icon. The preset cancellation action may be predetermined, and the correspondence between the preset cancellation action and the between-folder moving cancelling operation of the program icon may also be predetermined.

In one exemplary embodiment, monitoring that there is a between-folder moving cancelling event of the application icon includes: monitoring that there is a preset cancelling operation on a preset key of the terminal, the preset cancelling operation on the preset key being corresponding to a between-folder moving cancelling operation of the application icon. The preset cancelling operation may be predetermined. The correspondence between the preset cancelling operation on the preset key and the between-folder moving cancelling operation of the application icon may also be predetermined.

The above embodiments simplify the procedure of moving an application icon in a folder, which shortens a moving time and enhances a user's experience.

An application scene of the present disclosure is described below. In this application scene, the method for managing the terminal application includes following steps.

In step 1, when it is monitored that a user needs to move an application icon in a folder (e.g., it is monitored that the user presses and holds down the application icon in the folder), all other folders on a desktop are visibly displayed in the current folder.

In step 2, after an operation of moving the application in the folder is completed, what is displayed in a current interface is still the application folder before the moving operation, and thus the interface does not need to be switched. The user may conveniently continue performing moving operations on other application icons in this folder. In other words, after the application icon is moved into any of folders, e.g., in a bottom folder area, the current folder is not closed, and the page visible to the user does not be switched, that is, the current page still displays the folder where the application icon is located originally.

In this application scene, when the user presses and holds down one application icon in a first folder, a list of all other folders on the current desktop is displayed in a screen visible area at a bottom of the folder. The user may drag the application icon in a pressed-and-hold state to any one folder and release hand (cancels the pressed-and-hold state of the application icon), and thus the application icon is moved into a corresponding second folder automatically (i.e., the application icon disappears in the first folder and is placed at a last position in the second folder).

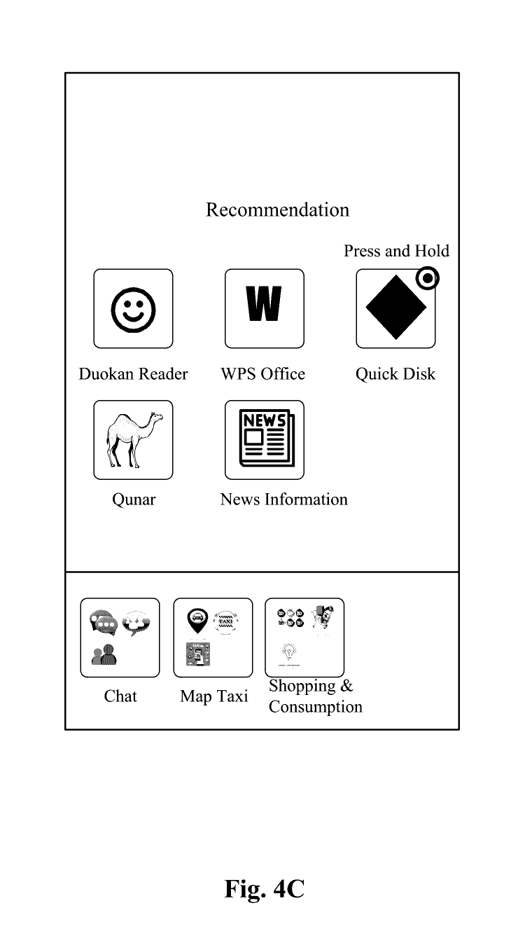

FIG. 5 is a block diagram of an apparatus for managing a terminal application, according to an exemplary embodiment. The apparatus includes a target folder displaying module 51 and a between-folder moving module 52.

The target folder displaying module 51 is configured to display at least one target folder in a visible area of a current desktop, when it is monitored that there is a between-folder moving trigger event of an application icon, the target folder being different from a first folder where the application icon is located.

The between-folder moving module 52 is configured to determine a selected target folder from the at least one target folder, delete the application icon from the first folder, and add the application icon into the selected target folder, when it is monitored that there is a between-folder moving end event of the application icon.

In the solution above, when it is monitored that there is the between-folder moving trigger event of the application icon, at least one target folder is displayed in the visible area of the current desktop; and when it is monitored that there is the between-folder moving end event of the application icon, a selected target folder is determined from the at least one target folder, the application icon is deleted from the first folder and the application icon is added into the selected target folder. During the whole process for moving the application icon, the user does not need too much manual operation, thus simplifying an operating process.

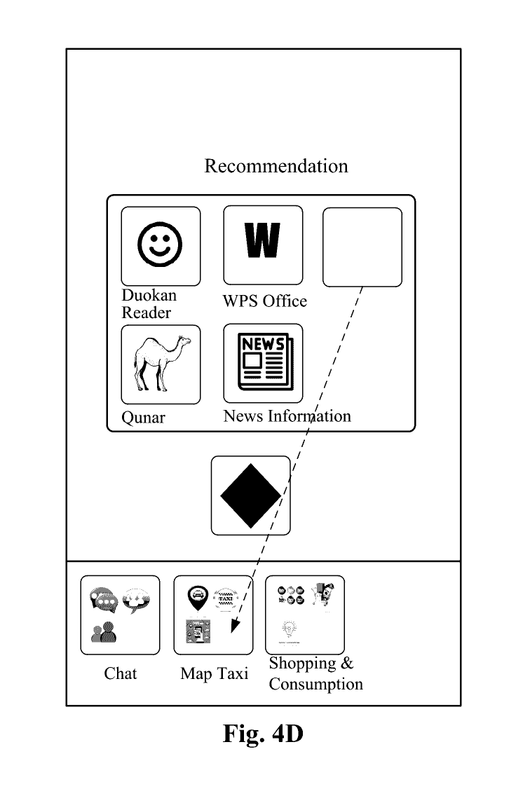

In one embodiment, shown in FIG. 6, the apparatus for managing a terminal application further includes: a maintaining module 53 configured to maintain a current active interface to display the first folder unfolded as, after the between-folder moving module 52 adds the application icon into the selected target folder

In the above embodiment, during the process for moving the application icon in the first folder, there is no switching in system pages, and a current page is maintained as the page where the first folder is located before the application icon to be moved is moved, and thus it is convenient for the user to continue to perform moving operations of other application icons in the first folder.

In one embodiment, the apparatus further includes a first monitoring module 54 configured to monitor a predetermined action performed on the program icon to be moved in the first folder unfolded.

In one embodiment, the apparatus further includes a sliding module 55 configured to slide the target folder displaying area to display target folders in other pages.

In one embodiment, the apparatus further includes a second monitoring module 56 configured to monitor that the application icon is switched from a pressed state to a released state; or a third monitoring module 57 configured to monitor a selecting operation to the target folder.

In one embodiment, the apparatus further includes a fourth monitoring module 58 configured to monitor a between-folder moving cancelling event of the application icon; and a cancelling module 59 configured to cancel the displaying of the target folder in the visible area of the current desktop, when it is monitored that there is the between-folder moving cancelling event of the application icon.

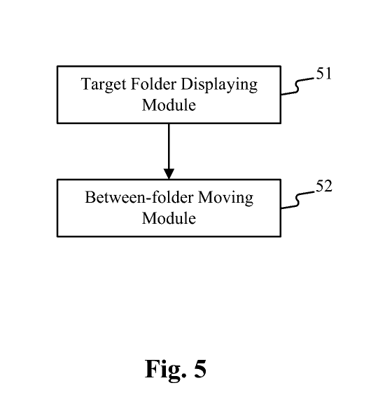

In one embodiment, as shown in FIG. 7, the target folder displaying module 51 includes: a first displaying sub-module 511 configured to display folders other than the first folder of the current desktop in the visible area of the current desktop; and a second displaying sub-module 512, configured to display folders other than the first folder of all desktops in the visible area of the current desktop.

In one embodiment, as shown in FIG. 7, the target folder displaying module 51 includes: a third displaying sub-module 513, configured to display the target folders in separate pages, if the number of the target folder is larger than the number of folder can be placed in a preset target folder displaying area within the visible area of the current desktop.

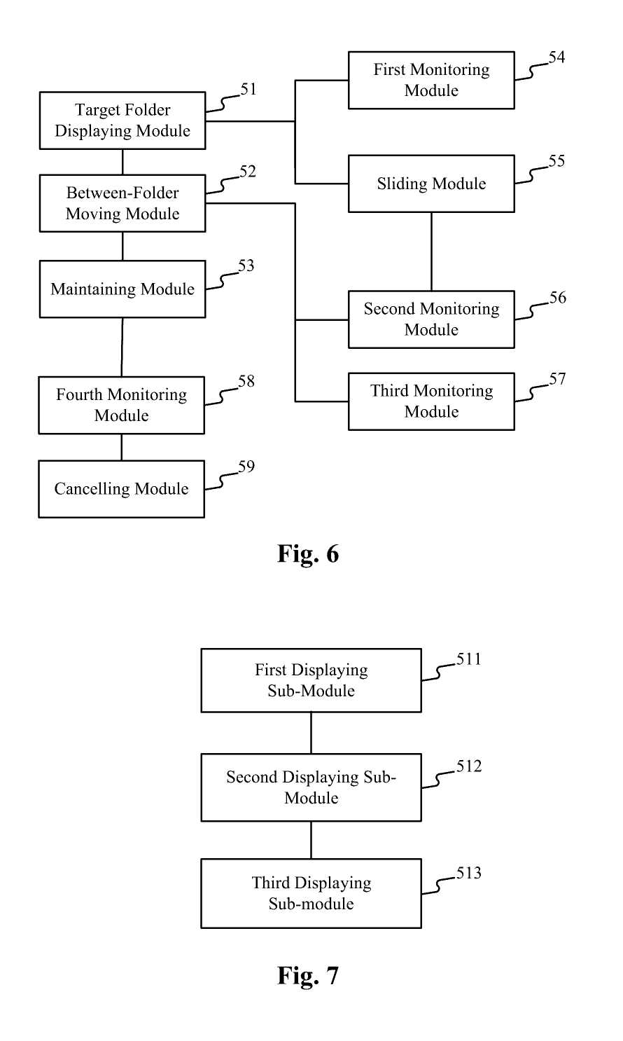

In one embodiment, as shown in FIG. 8, the between-folder moving module 52 includes: an arranging sub-module 521 configured to arrange application icons other than the application icon in the first folder according to a preset rule and display the arranged application icons; and an adding sub-module 522 configured to add the application icon into a preset location in the selected target folder.

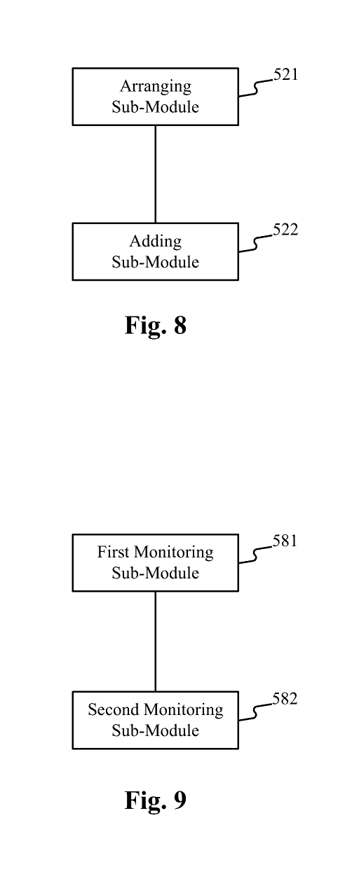

In one embodiment, as shown in FIG. 9, the fourth monitoring module 58 includes: a first monitoring sub-module 581 configured to monitor a preset cancellation action performed on the current desktop, the preset cancellation action being corresponding to a between-folder moving cancelling operation of the application icon; and a second monitoring module 582 configured to monitor a preset cancelling operation of a preset key of a terminal, the preset cancelling operation of the preset key being corresponding to a between-folder moving cancelling operation of the application icon.

In the above embodiments, during the whole process for moving the application icon, the user does not need too much manual operation, thus simplifying an operating process.

With respect to the devices in the above embodiments, the specific manners for performing operations for individual modules therein have been described in detail in the embodiments regarding the methods for managing a terminal application, which will not be repeated herein.

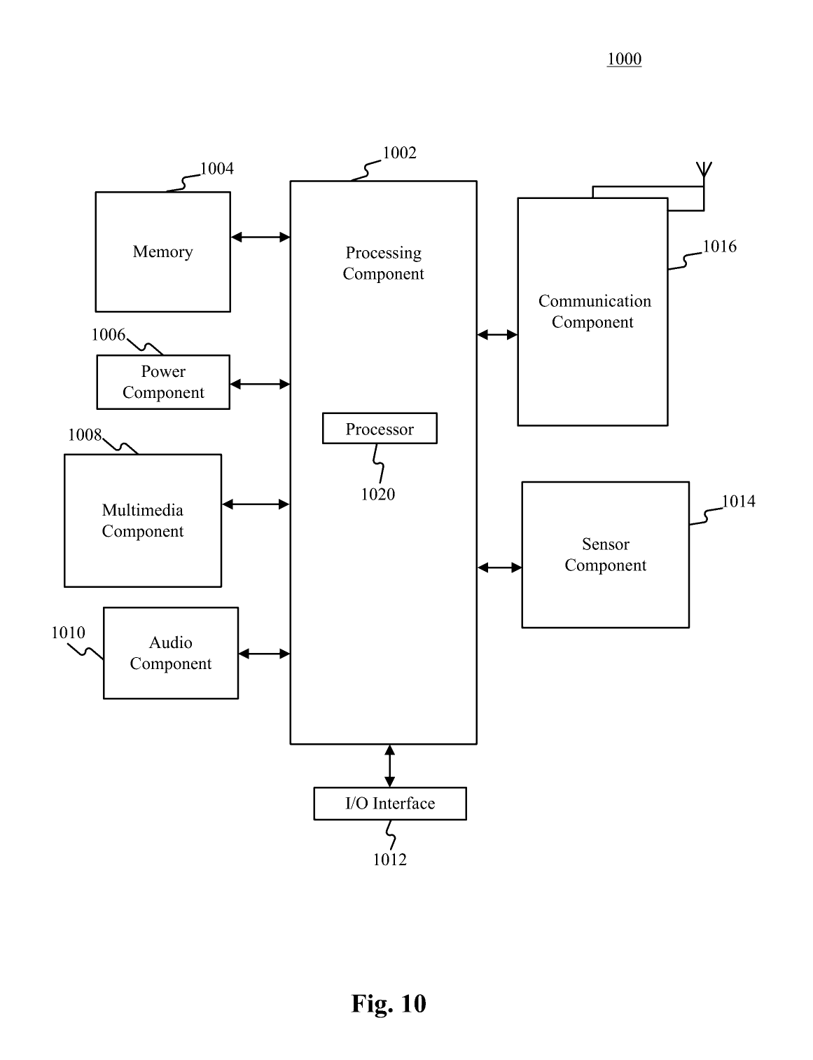

FIG. 10 is a black diagram of a device 1000 for managing a terminal application according to an example embodiment. The apparatus is applicable for a terminal device. For example, the device 1000 may be a mobile phone, a computer, a digital broadcast terminal, a messaging device, a gaming console, a tablet, a medical device, exercise equipment, a personal digital assistant, and the like.

Referring to FIG. 10, the device 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the device 1000, such as the operations associated with display, telephone calls, data communications, camera operations, and recording operations. The processing component 1002 may include one or more processors 1020 to execute instructions to perform all or part of the steps in the above described methods. Moreover, the processing component 1002 may include one or more modules which facilitate the interaction between the processing component 1002 and other components. For instance, the processing component 1002 may include a multimedia module to facilitate the interaction between the multimedia component 1008 and the processing component 1002.

The memory 1004 is configured to store various types of data to support the operation of the device 1000. Examples of such data include instructions for any applications or methods operated on the device 1000, contact data, phonebook data, messages, pictures, video, etc. The memory 1004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the device 1000. The power component 1006 may include a power management system, one or more power sources, and any other components associated with the generation, management, and distribution of power in the device 1000.

The multimedia component 1008 includes a screen providing an output interface between the device 1000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1008 includes a front camera and/or a rear camera. The front camera and the rear camera may receive an external multimedia datum while the device 1000 is in an operation mode, such as a photographing mode or a video mode. Each of the front camera and the rear camera may be a fixed optical lens system or have focus and optical zoom capability.

The audio component 1010 is configured to output and/or input audio signals. For example, the audio component 1010 includes a microphone (“MIC”) configured to receive an external audio signal when the device 1000 is in an operation mode, such as a call mode, a recording mode, and a voice recognition mode. The received audio signal may be further stored in the memory 1004 or transmitted via the communication component 1016. In some embodiments, the audio component 1010 further includes a speaker to output audio signals.

The I/O interface 1012 provides an interface between the processing component 1002 and peripheral interface modules, such as a keyboard, a click wheel, buttons, and the like. The buttons may include, but are not limited to, a home button, a volume button, a starting button, and a locking button.

The sensor component 1014 includes one or more sensors to provide status assessments of various aspects of the device 1000. For instance, the sensor component 1014 may detect an open/closed status of the device 1000, relative positioning of components, e.g., the display and the keypad, of the device 1000, a change in position of the device 1000 or a component of the device 1000, a presence or absence of user contact with the device 1000, an orientation or an acceleration/deceleration of the device 1000, and a change in temperature of the device 1000. The sensor component 1014 may include a proximity sensor configured to detect the presence of nearby objects without any physical contact. The sensor component 1014 may also include a light sensor, such as a CMOS or CCD image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate communication, wired or wirelessly, between the device 1000 and other devices. The device 1000 can access a wireless network based on a communication standard, such as WiFi, 2G; or 3G or a combination thereof. In one example embodiment, the communication component 1016 receives a broadcast signal or broadcast associated information from an external broadcast management system via a broadcast channel. In one example embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the device 1000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as included in the memory 1004, executable by the processor 1020 in the device 1000, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of submodules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for managing a terminal application, comprising:
displaying at least one target folder in a visible area of a current desktop, when monitoring that there is a between-folder moving trigger event of an application icon, the target folder being different from a first folder where the application icon is located; and
determining a selected target folder from the at least one target folder, deleting the application icon from the first folder, and adding the application icon into the selected target folder, when monitoring that there is a between-folder moving end event of the application icon.

2. The method of claim 1, further comprising:
after deleting the application icon from the first folder and adding the application icon into the selected target folder, maintaining a current active interface to display the first folder which is unfolded.

3. The method of claim 1, wherein monitoring that there is a between-folder moving trigger event of an application icon comprises:
monitoring that there is a predetermined action performed on the application icon to be moved in the first folder which is unfolded.

4. The method of claim 1, wherein displaying at least one target folder in a visible area of a current desktop comprises:
displaying one or more folders of the current desktop other than the first folder in the visible area of the current desktop; or
displaying one or more folders of all desktops other than the first folder in the visible area of the current desktop.

5. The method of claim 1, wherein displaying at least one target folder in a visible area of a current desktop comprises:
displaying the target folders in separate pages, if a number of the target folders is larger than a number of folders placeable in a preset target folder displaying area within the visible area of the current desktop, and
the method further comprises:
causing the target folder displaying area to slide to display target folders in other pages.

6. The method of claim 1, wherein monitoring that there is a between-folder moving end event of the application icon comprises:
monitoring that the application icon is switched from a pressed state to a released state; or
monitoring that there is a selecting operation on the target folder.

7. The method of claim 1, wherein deleting the application icon from the first folder and adding the application icon into the selected target folder comprises:
deleting the application icon from the first folder, arranging application icons other than the application icon in the first folder according to a preset rule, and displaying the arranged application icons in the first folder; and
adding the application icon into a preset location in the selected target folder.

8. The method of claim 1, further comprising:
cancelling displaying of the target folder in the visible area of the current desktop, when monitoring that there is a between-folder moving cancelling event of the application icon.

9. The method of claim 8, wherein monitoring that there is a between-folder moving cancelling event of the application icon comprises:
monitoring that a preset cancellation action is performed on the current desktop, the preset cancellation action being corresponding to a between-folder moving cancelling operation of the application icon; or
monitoring that there is a preset cancelling operation on a preset key of a terminal, the preset cancelling operation on the preset key being corresponding to a between-folder moving cancelling operation of the application icon.

10. A terminal for managing a terminal application, comprising:
a processor; and
a memory for storing instructions executable by the processor,
wherein the processor is configured to:
display at least one target folder in a visible area of a current desktop, when monitoring that there is a between-folder moving trigger event of an application icon, the target folder being different from a first folder where the application icon is located; and
determine a selected target folder from the at least one target folder, delete the application icon from the first folder, and add the application icon into the selected target folder, when monitoring that there is a between-folder moving end event of the application icon.

11. The terminal of claim 10, wherein the processor is further configured to:
maintain a current active interface to display the first folder which is unfolded, after deleting the application icon from the first folder and adding the application icon into the selected target folder.

12. The terminal of claim 10, wherein the processor is further configured to:
monitor that there is a predetermined action performed on the application icon to be moved in the first folder unfolded.

13. The terminal of claim 10, wherein the processor is configured to:
display one or more folders of the current desktop other than the first folder in the visible area of the current desktop; or
display one or more folders of all desktops other than the first folder in the visible area of the current desktop.

14. The terminal of claim 10, wherein the processor is configured to:
display the target folders in separate pages, if a number of the target folders is larger than a number of folders placeable in a preset target folder displaying area within the visible area of the current desktop; and
cause the target folder displaying area to slide to display target folders in other pages.

15. The terminal of claim 10, wherein the processor is further configured to:
monitor that the application icon is switched from a pressed state to a released state; or
monitor a selecting operation on the target folder.

16. The terminal of claim 10, wherein processor is configured to:
arrange application icons other than the application icon in the first folder according to a preset rule and display the arranged application icons in the first folder; and
add the application icon into a preset location in the selected target folder.

17. The terminal of claim 10, wherein the processor is further configured to:
monitor a between-folder moving cancelling event of the application icon; and
cancel displaying of the target folder in the visible area of the current desktop, when it is monitored that there is the between-folder moving cancelling event of the application icon.

18. The terminal of claim 17, wherein the processor is configured to:
monitor that a preset cancellation action is performed on the current desktop, the preset cancellation action being corresponding to a between-folder moving cancelling operation of the application icon; or
monitor that there is a preset cancelling operation on a preset key of the terminal, the preset cancelling operation on the preset key being corresponding to a between-folder moving cancelling operation of the application icon.

19. A non-transitory computer readable storage medium having stored therein instructions that, when executed by a processor of a terminal, cause the terminal to perform a method for managing a terminal application, the method comprising:
displaying at least one target folder in a visible area of a current desktop, when monitoring that there is a between-folder moving trigger event of an application icon, the target folder being different from a first folder where the application icon is located; and
determining a selected target folder from the at least one target folder, deleting the application icon from the first folder, and adding the application icon into the selected target folder, when monitoring that there is a between-folder moving end event of the application icon.
